(19) United States
(12) Patent Application Publication
(10) Pub. No.: US 2015/0299057 A1
(43) Pub. Date: Oct. 22, 2015

(54) SEED COATING COMPOSITION

(71) Applicant: DSM IP ASSETS B.V., Heerlen (NL)

(72) Inventors: Jurgen SCHEERDER, Waalwijk (NL); Gerardus Cornelis OVERBEEK, Echt (NL); Luppo EDENS, Echt (NL)

(21) Appl. No.: 14/443,820

(22) PCT Filed: Nov. 21, 2013
(86) PCT No.: PCT/EP2013/074389

§ 371 Date: May 19, 2015

(30) Foreign Application Priority Data
Nov. 21, 2012 (EP) 12193651.2

(51) Int. Cl. C05C 11/00; A01G 1/00; A01C 1/06

(52) U.S. Cl. CPC C05C 11/00; A01C 1/06; A01G 1/001

(57) ABSTRACT

The present invention relates to a seed treatment composition comprising a waterborne resin and a water dispersible plant protein. The invention is further directed to the production of these compositions and to the uses of these compositions.

### FIELD OF THE INVENTION

The invention relates to a seed treatment composition and to a seed comprising such a seed treatment composition. The invention further relates to a method for the preparation of the seed treatment composition and to a method for the application of the seed treatment composition to a seed. The invention also relates to a method for growing a plant and to use of a seed treatment composition to improve seed germination and/or to improve seedling development.

### BACKGROUND OF THE INVENTION

The successful establishment of crops from seed depends on a broad array of factors including the species sown, the inherent vigour of the seeds, the soil type and its fertility, the climatic conditions, the time of year, sowing depth, soil tilth, method of soil cultivation and sowing, and the presence or absence of antagonistic or beneficial organisms such as weeds, insects, diseases, rhizobia, or mycorrhizas.

Farmers have an opportunity to control only some of these factors; many factors remain uncontrolled and can, either singly or in combination, cause a delay or reduction in establishment. Commonly, farmers attempt to overcome some of these adverse conditions by applying materials such as herbicides and fertilisers to the whole area of land to be planted. Such broad-acre applications can be expensive and there is a risk of considerable financial loss if establishment is inadequate or fails altogether.

An alternative approach is to apply materials either in “bands” adjacent to the seed or on the seeds themselves in seed “coatings” in an effort to increase the effectiveness of the treatments. Seed coating is a mechanism of applying needed materials in such a way that they affect the seed or soil at the seed-soil interface. Thus, seed coating provides an opportunity to package effective quantities of materials such that they can influence the microenvironment of each seed. By not having to treat the remaining bulk of their soil, farmers may be able to save on the inputs required and the associated costs of applying them.

Thus, seed coatings may be applied to incorporate ingredients that will protect the seed against insect and microbial damage or that will facilitate the germination of the seed.

### SUMMARY OF THE INVENTION

The invention concerns compositions which may be used to treat seeds. That is to say, the invention relates to seed treatment compositions. Typically, these compositions will be in the form of aqueous micrometer-thin films deposited on a seed. They may though be compatible with other types of seed coating, such as encrustments and pelleting.

The seed treatment compositions are based on mixtures of a water dispersible plant protein, preferably deamidated wheat gluten, and a waterborne resin. That is to say, the seed treatment compositions of the invention are polymer-based seed coatings.

Advantages of a polymer-based seed coating incorporating a water dispersible plant protein, preferably deamidated gluten, include:
biodegradability;
sustainability; and
degradation of the incorporated dispersible plant protein generates the free amino acids that will stimulate growth of the seedling.

Further advantages observed in relation to the seed treatment compositions of the invention include:
known and versatile formulation knowledge is readily available to produce very thin hydrophobic or hydrophilic coatings;
the ability to use advanced coating methods like fluidized bed coatings (nowadays small scale primitive application equipment is used resulting in high labour costs).

According to the invention, there is thus provided a seed treatment composition comprising a waterborne resin and a water dispersible plant protein.

The invention also relates to:
a seed comprising a seed treatment composition of the invention;
a method for the preparation of a seed treatment composition, which method comprises:
   i. dispersing a water dispersible plant protein in an aqueous solution; and
   ii. mixing the dispersed plant protein obtained with a waterborne resin.
a method for the application of a seed treatment composition to a seed, which method comprises spraying, dipping or brushing a seed treatment composition of the invention onto the seed;
a method for growing a plant, said method comprising:
   a) sowing a seed of the invention; and
   b) allowing the plant to grow from the seed; and
use of a seed treatment composition of the invention to improve seed germination and/or to improve seedling development.

### DETAILED DESCRIPTION OF THE INVENTION

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

There are several reasons why seed coatings are used:
1. To protect the seed during storage, distribution, seeding and the early germination stages
2. Act as carrier for ingredients (for example fungicides, herbicides, insecticides or active enzymes) needed to protect the seed. Seed coatings allow one to influence the microenvironment of the seed limiting a widespread use of such ingredients. It offers a cost effective solution.
3. Allow a better distribution of the seeds, which is especially important for very expensive and small seeds such as tomato seeds.

In addition to these generic advantages the current invention offers several additional advantages.
1. By using a high amount of a water dispersible plant protein as part of the seed coating composition a high level of biodegradability is achieved. In addition, plant proteins are a renewable source.
2. By using waterborne resins as part of the coating composition, properties such as seed adhesion, coating hardness, mechanical properties and barrier properties (in particular against water) can be controlled.
3. These waterborne coatings are physically drying (they can be dried at elevated temperatures) and do not need additional crosslinking to build up their properties (one pot concept). This means that the addition of crosslinker is not needed (this is for instance described in EP 1036492 to Aventis). Such crosslinkers are added just prior to the application of the coating and because of their high reactivity the pot life of these coatings is restricted. In addition, the high reactivity of such crosslinkers also means that these typically have a negative toxicity profile and it is undesirable to have such ingredient come in contact with seeds that are intended for human consumption. Examples of such crosslinkers include polyisocyanates, melamines, formaldehyde, polyaziridines, epoxies.
4. There is a trend to tailor the seed germination properties towards the level of the individual farmer and his or her specific soil conditions. To this end a combination of a degradable polymer (a water dispersible plant protein) with a resin that allows one to control the coating properties makes such tailor made solution possible.

The invention thus provides, a seed treatment composition comprising a waterborne resin and a water dispersible plant protein, which preferably is deamidated wheat gluten. The water disposable plant protein may be a single protein, or class of proteins, or a mixture of proteins (such as a crude protein preparation obtained from a plant). The water disposable plant protein may have no or substantially no enzymatic activity.

The water dispersible plant protein may be self-dispersible, meaning that no base or acid would be needed to disperse it in water. Stirring and/or heating could be sufficient. The pH after dispersion may be from pH 2 to pH 12, preferably pH 3 to pH 10 or more preferably pH 5 to pH 9.

Alternatively, the water dispersible plant protein may be dispersible in presence of an acid or base. If present, the acid or base may be organic or inorganic. Examples of suitable bases include ammonia, dimethylethanolamine, or metalhydroxides such as sodium hydroxide or potassium hydroxide. Examples of suitable acids include formic acid, acetic acid, citric acid, propionic acid, lactic acid or acids such as HCl.

A number of water dispersible plant proteins are commercially available, but most of such proteins are relatively expensive because of their pure and food-grade character. Nowadays a worldwide trend is developing in which the recovery of plant proteins from waste streams is receiving serious attention for reasons of sustainability and foreseen worldwide protein shortages. Spin-offs of these efforts are becoming visible in the recovery of protein from rice bran and rapeseed press cake. Highly water dispersible proteins derived from these streams may be used according to the invention. Other cheaply available crude plant protein preparations which may be used in the invention include soy proteins, canola/rapeseed proteins, pea proteins and lupin proteins.

Among the high quality plant proteins, wheat gluten is cheap and widely available. Wheat gluten incorporates a very high level (37%) of the amino acid glutamine which provides the nitrogen (in the side chain of the glutamine) for growth of the seedling. Unfortunately, wheat gluten is almost insoluble in water and is not suitable in a seed coating according to the present invention as illustrated in the first Example of this application. To overcome this problem, we have established that the use of deamidated wheat gluten may be used to generate film forming compositions. In this deamidated wheat gluten, at least a portion of the glutamine residues have been chemically converted into glutamate residues.

According to the invention, a deamidated gluten may be one on which at least about 10% of gluten side chains have been deamidated, for example at least about 20%, such at least about 30%, for instance at least about 50% of gluten side chains have been deamidated.

The source of a deamidated gluten may be a plant from the tribe Triticeae. Suitable plant sources of deamidated gluten thus include wheat, barley and rye.

Deamidated wheat gluten has a considerably improved water solubility, is also commercially available at acceptable costs, is as biodegradable and sustainable as natural wheat gluten and degradation will yield free amino acids (including some nitrogen) for stimulating growth of the encapsulated seeds.

Waterborne resins used to prepare coating compositions are well known to those skilled in the art and may comprise any suitable polymeric species that are dispersible in an aqueous carrier medium. Preferred waterborne resins suitable for use in the present invention are selected from the group consisting of: acrylics (which term includes methacrylics), polyurethanes, urethane acrylics, polyesters (e.g. alkyds) and uralkyds. Waterborne acrylic resins (also sometimes described as vinyl polymers) are generally obtained by addition polymerisation of at least one olefinically unsaturated monomer usually in a free radical process, emulsion polymerisation and/or solution dispersion polymerisation being preferred and emulsion polymerisation being more preferred. Acrylic polymers may exhibit a single phase or multiple phases. Examples of conventional waterborne acrylic resins, ingredients and methods for preparing them are very well known to those skilled in the art and are described in many publications (for example by the applicant in WO 2006-007978, e.g. see page 5, lines 33 to page 8 line 5). In the present invention waterborne acrylic coatings are particularly suited to increase the coating hardness, water barrier and improving adhesion to seeds.Waterborne polyurethane resins are generally derived from polycondensation of polyisocyanates and isocyanate reactive compounds (e.g. polyols) and are usually chain extended with a further compound containing an active hydrogen. Waterborne polyurethanes may be prepared by any suitable process and may exhibit a single phase or multiple phases. Examples of conventional waterborne polyurethane resins, ingredients and methods for preparing them are very well known to those skilled in the art and are described in many publications (for example by the applicant in WO2006-097318, e.g. see page 2 line 31 to page 5 line 21).

Waterborne urethane acrylic resins generally comprise both polyurethane part and an acrylic part, they may be physical blends of these polymer types or a polymer in which an acrylic region and a polyurethane region are chemically bound together or the acrylic polymer is prepared in presence of the polyurethane. Waterborne urethane acrylics may be prepared by any suitable process and may exhibit a single phase or multiple phases. Examples of conventional waterborne urethane acrylic resins, ingredients and methods for preparing them are very well known to those skilled in the art and are described in many publications (for example by the applicant in EP309113).

In the present invention waterborne polyurethanes and urethane-acrylics are particularly suited to improve the mechanical properties of the seed coatings. Where coatings with a high impact resistance are needed polyurethanes are preferred. Waterborne polyester resins generally comprise any “generic” polyester, optionally containing urethane and/or amide groups. When the polyester resin does not contain urethane and/or amide groups it may also be described as a “pure” polyester. Where the polyester also comprises a fatty acid chain such polyesters are known as alkyds and preferred alkyds also contain autoxidisable olefinic unsaturated groups. Waterborne polyesters (including alkyds) may be prepared by any suitable process and may exhibit a single phase or multiple phases. Examples of conventional waterborne polyesters and alkyd resins, ingredients and methods for preparing them are very well known to those skilled in the art and are described in many publications (for example by the applicant in WO2009/121892 or WO2009/121885).

Waterborne uralkyd resins generally comprise both a polyurethane part and an alkyd part, they may be physical blends of these polymer types or a polymer in which an alkyd region and a polyurethane region are bound together. Waterborne uralkyds may be prepared by any suitable process and may exhibit a single phase or multiple phases. Examples of conventional waterborne uralkyd resins, ingredients and methods for preparing them are very well known to those skilled in the art and are described in many publications (for example by the applicant in WO2008-086977).

In the present invention waterborne polyesters (such as alkyds) may be useful as these resins have a higher biodegradability than acrylics and urethanes. Hydrophobic polyesters and alkyds are very useful where a coating with high water barrier is required. Any suitable combinations of the waterborne resins can be used to prepare a tailor made coating compositions with desired properties. For example a hydrophobic resin with high water barrier (such as a polyester) could be blended with a hydrophilic resin that provides improved adhesion (such as an acrylic) to provide a coating composition with the combination of both properties.

Similarly the properties of the component water borne resins may be modified to obtain desired coating properties. For example controlling the hydrophilicity and hydrophobicity of the water borne resin may change the water permeability of the coating. Modifying the glass transition temperature (Tg) of the various polymer phases (e.g. in a multiple phase acrylic polymer) may control coating hardness and adhesion. Introducing additional functional groups (such as (poly)amine, amide, cyclic ureido, acid, hydroxyl, acetoacetoxy, tertiary amine) to the water borne resin may increase the adhesion of the coating to the seeds. Mechanical properties of polyurethanes may also be modified by adjusting parameters such as the NCO/OH ratio, degree of chain extension and/or amount of ionizable groups and/or by the selection of isocyanates and polyols.

In one preferred embodiment the waterborne resin may comprise a multiphase polymer (e.g. a multi-phase acrylic resin with water as the continuous phase) as a means of incorporating several different, otherwise potentially incompatible, properties into one resin, which may be then blended with the water dispersible plant protein, such as deamidated gluten. Examples of opposing properties that may be of interest to incorporate in such a multiple phase resin comprise: a) a higher Tg phase (e.g. for hardness) and a lower Tg phase (e.g. for adhesion and/or barrier); b) a more hydrophilic phase (e.g. for adhesion) and a more hydrophobic phase (e.g. for barrier properties); and/or c) a lower molecular weight phase (e.g. for film formation) and a higher molecular weight phase (e.g. for good mechanical properties).

Typically then, a seed treatment composition of the invention is one which is film forming.

The amount of water dispersible plant protein (such as gluten, in particular deamidated gluten):waterborne resin in a composition according to the invention may be from about 50:50 to about 90:10 (solid/solid). This ratio allows the combination of a high degree of biodegradability with controlling coating properties such as adhesion, hardness, mechanical properties and barrier. This is a cost effective way of realizing this.

Thus, a seed treatment composition according to the invention may comprise:
a. from about 50% (w/w) to about 10% (w/w) of a waterborne resin; and
b. from about 50% (w/w) to about 90% (w/w) of a water dispersible plant protein; and

In addition, a seed treatment composition of the invention may comprise:
c. from about 0.001% (w/w) to about 5% (w/w) of a pesticide, a fertilizer, a bioregulating additive, an additive for increasing the fertilizer efficiency, plant productivity, growth and nutrient accumulation and adjuvants or any combination thereof.

Such additional components of a composition of the invention include ingredients from one of more of the following five categories a) to e):
a) fungicides, insecticides, acaricides, antidotes, safener;
b) fertilisers, micronutrients, inoculants;
c) bioregulators of natural or synthetic origin which are either hormones or interfere in hormone metabolism and do not influence plant nutrition;
d) bioregulators which interfere with plant growth by diverse, mostly unknown mechanisms, which may be related for instance to enhanced nutrient uptake; and
e) adjuvants which provide certain physical properties to the formulation, to the treatment appearance and properties, to the seeds or to the soil or aerial environment.

The invention further provides a seed comprising a seed treatment composition according to any one of the preceding claims. Such a seed typically comprises the seed treatment composition in the form of a film coating. That is to say, a seed may be coated with a seed treatment composition of the invention. Coating may be complete (i.e. over the entire surface area of a seed) or partial (i.e. over less than the entire area of a seed).

A method for the preparation of a seed treatment composition is also provided. Such a method comprises:
a. dispersing a water dispersible plant protein, such as deamidated gluten, in an aqueous solution; and
b. mixing the dispersed plant protein, such as deamidated gluten, obtained in a. with a waterborne resin.

A composition of the invention may be applied to a seed. Accordingly, the invention provides a method for the application of a seed treatment composition to a seed, which method comprises spraying, dipping or brushing a seed treatment composition according to the invention onto a seed. A method for the application of a seed treatment composition to a seed may thus comprise coating a seed, completely or partially, with a seed treatment composition according to the invention.

A seed coated with a seed treatment composition of the invention may be grown using methods well known to those skilled in the art. A method for growing a plant may thus comprise:
a. sowing a seed according to the invention; and
b. allowing the plant to grow from the seed.

A seed treatment composition of the invention may thus be used to improve seed germination and/or to improve seedling development.

The methods and compositions of the invention may be used with crops or decorative plants and are particularly useful for treating commercially important crops. Such plants or crops include, but are not limited to dicots, which include for example spring and winter wheat, legumes such as soybeans or beans, and solanaceae such as tomatoes, peppers and potatoes, as well as monocots, for example corn, onions, bulbs, rice, sorghum and turf.

Seeds to be treated using the seed treatment compositions described herein include, for example, cereals (wheat, barley, rye, oats, rice, sorghum and related crops); beet (sugar beet and fodder beet); stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans); cucumber plants (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocados, cinnamon, camphor); ornamental plants (flowers, shrubs, broad-leaved trees and evergreens, such as conifers); and other plants such as maize, tobacco, nuts, coffee, sugar cane, tea, vines, hops, bananas and natural rubber plants.

A reference herein to a patent document or other matter which is given as prior art is not to be taken as an admission that that document or matter was known or that the information it contains was part of the common general knowledge as at the priority date of any of the claims.

The disclosure of each reference set forth herein is incorporated herein by reference in its entirety.

The present invention is further illustrated by the following Examples:

### EXAMPLES

### Example 1

60 gram wheat gluten was mixed under mild stirring with 240 gram water yielding a mixture with poorly dispersed gluten as evidenced by significant agglomeration of gluten. Upon the addition of ammonia (25%) to pH 7.5-8.5 the agglomerated gluten were not dispersed properly. Increasing the pH further by adding more ammonia, increasing the stirring rate, lowering the solid content to 10 wt % by adding demineralized water or by increasing the temperature to 40° C. did not yield a homogeneous dispersion. When stirring was stopped the gluten settled quickly. This material was not suited to be combined with another resin.

### Example 2

60 gram deamidated gluten (Solpro S100, Syral, France) was mixed under mild stirring with 240 gram water. Ammonia (25%) was added until the pH was 7.5-8.5. Upon addition of the ammonia the viscosity dropped and a homogeneous dispersion was obtained. The solid content of the final dispersion was 20%.

45.7 gram of the S100 dispersion was mixed under mild stirring with 5 gram NeoCryl XK-90, a (meth)acrylic copolymer dispersion available from DSM Coating Resins (Zwolle, The Netherlands). After stirring for 30 minutes a homogeneous dispersion was obtained and upon applying a 100 micron wet film onto a glass plate and drying at room temperature, a coating without any visible defects was obtained.

1. A seed treatment composition comprising a waterborne resin and a water dispersible plant protein.

2. A seed treatment composition according to claim 1, wherein the water dispersible plant protein is deamidated gluten.

3. A seed treatment composition according to claim 1, wherein the waterborne resin is an acrylic, a polyurethane, a urethane acrylics, a polyesters or a uralkyds

4. A seed treatment composition according to claim 2, wherein at least about 20% of glutamine side chains of the gluten have been deamidated.

5. A seed treatment composition according to claim 2, wherein the gluten is derived from a plant of the tribe Triticeae.

6. A seed treatment composition according to claim 1, which is a film forming composition.

7. A seed treatment composition according to claim 1, which comprises:
a. from about 50% (w/w) to about 10% (w/w) of a waterborne resin;
b. from about 50% (w/w) to about 90% (w/w) of a water dispersible plant protein; and

[symbol]

8. A seed treatment composition according to claim 6 which comprises:
c. from about 0.001% (w/w) to about 5% (w/w) of a pesticide, a fertilizer, a bioregulating additive, an additive for increasing the fertilizer efficiency, plant productivity, growth and nutrient accumulation and adjuvants or any combination thereof.

9. A seed comprising a seed treatment composition according to claim 1.

10. A seed according to claim 9, wherein the seed comprises the seed treatment composition in the form of a film coating.

11. A method for the preparation of a seed treatment composition, which method comprises:
a. Dispersing a water dispersible protein, such as deamidated gluten, in an aqueous solution; and
b. mixing the dispersed protein, such as deamidated gluten, obtained in a. with a waterborne resin.

12. A method for the application of a seed treatment composition to a seed, which method comprises spraying, dipping or brushing a seed treatment composition according to claim 1 onto the seed.

13. A method for growing a plant, said method comprising:
a) sowing a seed according to claim 9; and
b) allowing the plant to grow from the seed.

14. Use of a seed treatment composition according to claim 1 to improve seed germination and/or to improve seedling development.
